(19) United States
(12) Patent Application Publication
(10) Pub. No.: US 2012/0285217 A1
(43) Pub. Date: Nov. 15, 2012

(54) METHOD AND DEVICE FOR DETERMINING THE OPERATING STATUS OF A PROBE FOR MEASURING THE AMOUNT OF SOOT IN THE EXHAUST FUMES OF A VEHICLE

(75) Inventors: Frederic Duault, Decines-Charpieu (FR); Stephane Raquin, Villefranche Sur Saone (FR); Laurence Achille, Villeurbanne (FR)

(73) Assignee: ELECTRICFIL AUTOMOTIVE, Miribel Cedex (FR)

(21) Appl. No.: 13/574,663

(22) PCT Filed: Feb. 15, 2011
(86) PCT No.: PCT/FR2011/050313

§ 371 Date: Jul. 23, 2012

(30) Foreign Application Priority Data
Feb. 16, 2010 (FR) 1051084

(51) Int. Cl. G01N 35/00

(52) U.S. Cl. 73/1.06; 73/23.2

(57) ABSTRACT

The invention provides a measuring device for measuring soot deposition, said device having a measuring probe (3) for measuring the quantity of soot deposited on a collection surface (2) of an elongate dielectric substrate, said probe including detection electrodes (6, 7) that are arranged in adjacent manner and that are for connecting to an electronic system that is capable of evaluating the quantity of soot deposited on the collection surface. In the invention, the device includes, for at least one detection electrode (6, 7), a measurement loop (B₁) that includes said at least one detection electrode (6, 7) and that is connected to a detection system for detecting the variation in the electric resistance of said measurement loop, so as to determine the operating state of said detection electrode.

The present invention relates to the field of measuring the quantity of soot deposited in the exhaust of an internal combustion engine of a vehicle, in particular a motor vehicle.

More precisely, the present invention relates to a device that makes it possible to determine the operating state, and in particular the degradation state, of a probe that measures the deposit of soot resulting from the polluting emissions coming from motor vehicle exhausts.

In view of environmental constraints, there exists a need to be able to quantify, with greater reliability and accuracy, the emissions of particles or of soot from engines.

In the prior art, various solutions have been proposed for detecting soot in exhaust gases.

For example, patent application FR 2 805 347 describes a measuring device including a probe that is interposed locally in the flow of gas, in such a manner as to capture the particles in the flow. The probe includes an elongate dielectric substrate that is provided with electrodes that are spaced apart from each other. The electrodes are connected to an electronic system making it possible to measure the variation in electric resistance that results from soot being deposited on the elongate dielectric substrate. The electronic system includes processor means that are capable of evaluating, from the measured resistance, the flowrate of the particles transported by the flow of gas, or the degree to which a filter element passing the flow of gas transporting the particles, has become choked.

Determining the degree to which the filter element has been choked makes it possible to determine the most appropriate moments for triggering a process for cleaning the filter element. In order to avoid the filter element becoming clogged, provision is made to regenerate it periodically by burning the deposited soot.

In order to provide an accurate measurement, the prior art propose various variant embodiments of measurement electrodes. It is known to make the detection electrodes in the form of rectangular pads. Patent applications DE 10 2007 046096 and WO 2008/006640 propose making measurement electrodes in the form of combs that are interleaved one in the other while being spaced apart from each other.

Whatever the shape in which electrodes are made, it should be observed that the electrodes should be made out of an electrically-conductive material that is able to withstand relatively high temperatures of about 900° C. and attacks that are generated by the various polluting emissions coming from exhaust gas.

In practice, there is the need to determine the operating state of the detection electrodes, so as to determine whether the absence of variation in the measured resistance comes from an absence of soot in the exhaust or from a degradation of the detection electrodes, which detection must be reliable and simple to implement.

The invention thus seeks to propose a technique that makes it possible, in simple and reliable manner, to determine the operating state of a probe that measures the quantity of soot deposited on a collection surface placed in the flow of polluting emissions coming from motor vehicle exhausts.

To achieve such an object, the method of the invention determines the operating state of a measuring probe for measuring the quantity of soot deposited on a collection surface, said probe including detection electrodes that are arranged in adjacent manner and that are for connecting to an electronic system that is capable of evaluating the quantity of soot that has been deposited.

In the invention:
at least one detection electrode is placed in a measurement loop; and
the variations in the electric resistance of the measurement loop are detected, so as to determine the operating state of the detection electrodes.

In addition and in combination, the method of the invention may further present at least one of the following additional characteristics:
a detection electrode is determined as being in an inoperative state when the variation in the electric resistance of the measurement loop including said detection electrode, exceeds a determined value;
at least one diagnostic resistor of determined resistance is placed in series with each detection electrode;
the diagnostic resistor is placed on a soot collection surface that optionally corresponds to the collection surface including the detection electrodes, or away from a soot collection surface;
the diagnostic resistor is placed in register with the collection surface, so as to form a heater resistor for regenerating the collection surface;
injecting a current of known value into each of the measurement loops, so as to detect variation in the electric resistance thereof;
injecting the current at regular intervals or after each stage of regenerating the detection electrodes;
the resistance of at least one diagnostic resistor placed in register with the collection surface is determined, so as to deduce the temperature of the measuring probe.

Another object of the invention is to propose a measuring device for measuring soot deposition on a collection surface of an elongate dielectric substrate, said device including detection electrodes that are arranged in adjacent manner and that are for connecting to an electronic system that is capable of evaluating the quantity of soot deposited on the collection surface.

In the invention, the device includes, for at least one detection electrode, a measurement loop that includes said detection electrode and that is connected to a detection system for detecting the variation in the electric resistance of said measurement loop, so as to determine the operating state of said detection electrode.

In addition and in combination, the measuring device of the invention may further present at least one of the following additional characteristics:
the dielectric substrate is in the form of an elongate plate defining a distal portion and a proximal portion and having first and second main faces, the detection electrodes and the collection surface being arranged on one of the main faces at the distal portion of the plate, at least one detection electrode being connected in series with at least one diagnostic resistor of determined resistance, arranged on at least one of the main faces of the plate;
a diagnostic resistor is placed on a soot collection surface that optionally corresponds to the collection surface including the detection electrodes;
a diagnostic resistor is placed away from the collection surface;
a diagnostic resistor is placed in register with the collection surface, so as to form a heater resistor for regenerating the collection surface;
at least one measurement loop comprises an electrical connection track directly connecting the detection electrode to a contact pad situated at the proximal portion of the plate, and an electrical connection track passing via a diagnostic resistor, between the detection electrode and a contact pad situated at the proximal portion of the plate;
at least one electrical connection track includes one portion arranged on one main face and another portion arranged on the other main face of the dielectric plate, the two portions being electrically connected together through the thickness of the dielectric plate, in such a manner that one of the contact pads of a measurement loop is situated on one main face while the other contact pad of the measurement loop is situated on the other main face.

Various other characteristics appear from the following description made with reference to the accompanying drawings which, by way of non-limiting example, show embodiments of the invention.

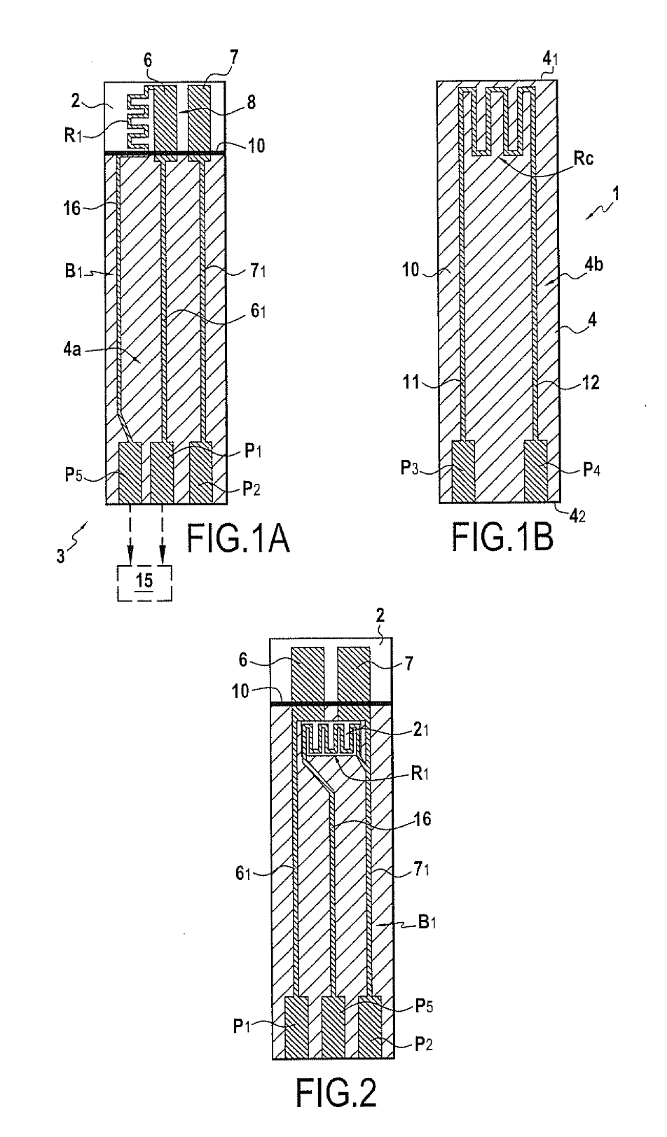

FIGS. 1A and 1B are front and rear views respectively of a first embodiment of a measuring device of the invention.

FIG. 2 shows a variant embodiment of the embodiment shown in FIGS. 1A and 1B.

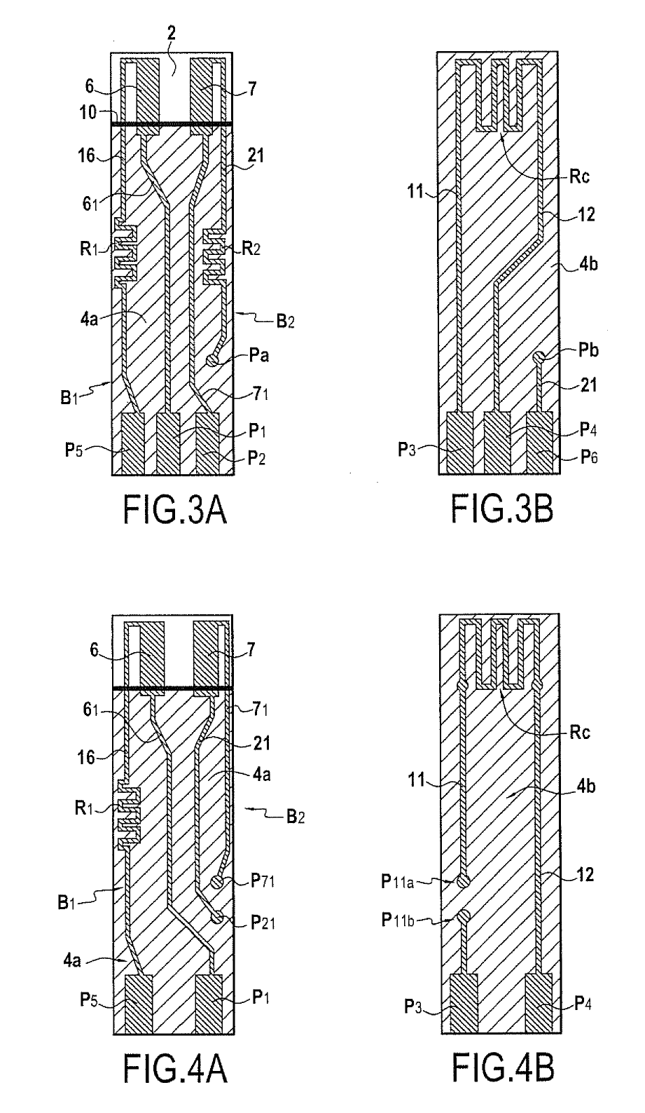

FIGS. 3A and 3B are front and rear views respectively of another embodiment of a measuring device of the invention.

FIGS. 4A and 4B are front and rear views respectively of another embodiment of the measuring device of the invention.

FIGS. 1A and 1B show a first embodiment of a device 1 adapted to measure the deposit of soot on a collection surface 2 of a measuring probe 3 placed in the exhaust gas of an internal combustion engine of a motor vehicle. The measuring probe 3 includes an elongate dielectric substrate 4 presenting a distal portion 4₁ that is mounted free so as to be in contact with the exhaust gas, and a proximal portion 4₂ that is mounted on a support that is not shown. In conventional manner, the elongate dielectric substrate 4 is mounted inside a protective tubular body that is not shown, but that is of any known type per se.

The elongate dielectric substrate 4 is in the form of a thin rectangular plate having a first main face 4a (FIG. 1A) that extends parallel to an opposite second main face 4b (FIG. 1B). For example, the elongate dielectric substrate 4 is made out of a ceramic material.

At its distal portion 4₁, the elongate dielectric substrate 4 includes detection electrodes that are arranged in adjacent manner or side by side. In the embodiment shown, the elongate dielectric substrate 4 includes a first electrode 6 and a second electrode 7 arranged on the first main face 4a and extending, at least in part, over the collection surface 2. The electrodes 6, 7 define between them an inter-electrode gap 8 for receiving soot that modifies the resistance of the gap 8.

The detection electrodes 6, 7 are shown in FIG. 1A in the form of pads of rectangular shape, but it is clear that the electrodes 6, 7 may be made in some other way, e.g. in the form of interleaved combs.

The detection electrodes 6, 7 are connected, via electrical connections, to an electronic system that is not shown but that is known per se, and that is capable of evaluating the quantity of soot that has been deposited on the collection surface 2. The detection electrodes 6, 7 are connected to respective contact pads P₁ and P₂ by means of respective electrical connection tracks 6₁ and 7₁ respectively. The electrical connection tracks 6₁, 7₁ are thus arranged on the first face 4a of the dielectric substrate 4, thereby providing the connections between the electrodes 6, 7 and the contact pads P₁ and P₂ arranged on the proximal portion 4₂ of the dielectric support 4.

In a preferred variant embodiment, the dielectric substrate 4 includes dielectric protection 10 that is adapted to cover all of the main face 4a of the dielectric substrate 4 except for the collection surface 2 that is provided with the electrodes 6, 7 and that is for receiving soot. The dielectric protection 10 is formed by a dielectric coating formed by silk-screen printing or by laminating, for example. In a preferred variant embodiment, the dielectric protection 10 also covers the second face 4b of the dielectric substrate 4.

In a preferred variant embodiment, the measuring probe 3 also includes a heater resistor Rc making it possible to regenerate the collection surface 2. The heater resistor Rc is situated at least in register with or facing the collection surface 2. In the embodiment shown in FIGS. 1A and 1B, the heater resistor Rc is arranged on the second main face 4b opposite from the first face 4a that is provided with the detection electrodes 6, 7. Naturally, it may be envisaged to form the heater resistor Rc at the core of, or inside, the dielectric substrate 4. In the embodiment shown, the heater resistor Rc is formed at the rear of the collection surface 2, i.e. directly facing the electrodes 6, 7. The heater resistor Rc is thus arranged in the proximity of the distal portion 4₁ of the plate and is connected via electrical connection tracks 11, 12 to respective contact pads P₃ and P₄ arranged at the proximal portion 4₂ of the dielectric substrate 4. Such a heater circuit is for connecting, via the contact pads P₃, P₄, to an electrical source that is controlled so as to enable an electric current to flow, and consequently so as to obtain regeneration of the probe. In the embodiment shown, the electrical connection tracks 11, 12 and the contact pads P₃, P₄ are arranged on the second face 4b.

In accordance with the invention, the measuring device 1 includes at least one measurement loop B₁ including at least one of the detection electrodes, namely the first electrode 6 in the embodiment shown in FIG. 1A. The measurement loop B₁ is for connecting to a detection system 15 for detecting variation in the electric resistance of the measurement loop B₁ with a view to determining the operating state of the detection electrode. The measurement loop B₁ presents a known electric resistance, and measuring its variation makes it possible to determine the degradation of at least the detection electrode forming part of this detection loop.

In the embodiment shown, the detection loop B₁ includes a diagnostic resistor R₁ of determined resistance, such that the measurement loop B₁ possesses a known resistance. For example, the resistance of the diagnostic resistor R₁ may present a known determined value lying in the range 1 ohm (Ω) to 1000Ω at ambient temperature, and preferably in the range 100Ω to 200Ω.

In the embodiment in FIG. 1A, the diagnostic resistor R₁ is placed at, or on, the collection surface 2, in the proximity of the electrodes 6 and 7. The diagnostic resistor R₁ is electrically connected in series to the first electrode 6, and, via an electrical connection track 16, to a contact pad P₅. As shown more precisely in FIG. 1A, the electrical connection track 16 thus provides an electrical connection between the diagnostic resistor R₁ arranged in the proximity of the distal portion 4₁ of the dielectric substrate 4 and the contact pad P₅ arranged in the proximity of the proximal portion 4₂ of the dielectric substrate 4. The diagnostic resistor R₁, the electrical connection track 16, and the contact pad P₅ are formed on the first surface 4a of the dielectric substrate 4.

It can be seen from the above description that the measurement loop B₁ thus comprises, in series, the contact pad P₁, the electrical connection track 6₁, the first electrode 6, the diagnostic resistor R₁, the electrical connection track 16, and the contact pad P₅. The measurement loop B₁ is connected, via the contact pads P₁ and P₅, to the detection system 15 for detecting variation in the resistance of the measurement loop B₁. In an advantageous variant embodiment, the detection system 15 thus injects a current of known value into the measurement loop B₁. The current is injected at regular intervals or after each stage of regenerating the detection electrodes 6, 7, while the temperature of the probe is known.

If the electric resistance of the measurement loop B₁ varies, it can thus be assumed that the first electrode 6 presents premature wear. By analogy, assuming that the electrodes 6 and 7 degrade in substantially identical manner, the detection of the degradation of the first detection electrode 6 also implies that degradation of the second detection electrode 7 has been detected. For example, it may be assumed that the measuring probe no longer provides a correct measurement when the variation in resistance exceeds a threshold value lying in the range 15% to 20%. When the variation in the resistance of the measurement loop B₁ reaches this critical threshold value, provision may be made to correct the signal of the probe via the detection system 15 and/or to change the probe.

In the embodiment shown in FIGS. 1A and 1B, the diagnostic resistor R₁ is placed on the soot collection surface 2.

FIG. 2 shows another variant embodiment in which the diagnostic resistor R₁ is placed on an auxiliary collection surface 2₁. In this embodiment, the auxiliary collection surface 2₁ is also arranged on the first surface 4a of the dielectric substrate 4, in the proximity of the collection surface 2. In the embodiment shown, the auxiliary collection surface 2₁ is formed by means of a window arranged in the dielectric protection 10, and on which the diagnostic resistor R₁ is formed. In this embodiment, the measurement loop B₁ is constituted by the contact pad P₂. the electrical connection track 7₁, the second electrode 7, the diagnostic resistor R₁, the electrical connection track 16, and the contact pad P₅.

In the embodiment shown in FIGS. 1A, 1B, and 2, the soot-deposit measuring device 1 includes only one measurement loop B₁. Naturally, it may be envisaged to make the measuring device with a measurement loop for each electrode 6, 7.

FIGS. 3A and 3B show another embodiment of the invention including two measurement loops B₁ and B₂ each including one of the electrodes, the first electrode 6 and the second electrode 7 respectively. In this variant embodiment, each measurement loop B₁, B₂ includes a respective diagnostic resistor, R₁ and R₂, arranged outside the collection surface 2. It should be observed that it may be envisaged to form the resistors R₁, R₂ inside the collection surface 2.

As can be seen more clearly in FIG. 3A, each diagnostic resistor R₁, R₂ is protected by the dielectric protection 10. Apart from this difference, the first measurement loop B₁ is identical to the measurement loop shown in FIG. 1A. The measurement loop B₁ is thus constituted by the contact pad P₁, the electrical connection track 6₁, the first electrode 6, the electrical connection track 16 provided with the diagnostic resistor R₁, and the contact pad P₅. The second measurement loop B₂ comprises the contact pad P₂, the electrical connection track 7₁, the second electrode 7, an electrical connection track 21, the diagnostic resistor R₂, and a contact pad P₆. In this embodiment, each measurement loop B₁, B₂ is electrically connected to the detection system 15 respectively via the contact pads P₁ & P₅ and P₂ & P₆.

In a preferred variant embodiment, the pad P₆ is not arranged on the first face 4a, but is formed on the second face 4b of the dielectric substrate 4, for reasons of compactness. Naturally, it may be envisaged to form all four contact pads P₁, P₅, P₂ and P₆ on the first face 4a of the dielectric substrate 4, while the contact pads P₃, P₄ for the heater resistor Rc are formed on the second face 4b of the dielectric substrate 4. In the embodiment shown in FIGS. 3A and 3B, the electrical connection track 21 comprises two segments that are arranged on each of the faces 4a, 4b of the substrate and that are connected together through the thickness of the dielectric substrate 4 at common connection points Pₐ, P_{b} that are arranged on the first and second faces 4a and 4b respectively of the dielectric substrate 4.

FIGS. 4A and 4B show another embodiment of the invention compared with the embodiment shown in FIGS. 3A and 3B. In this embodiment, one of the diagnostic resistors, e.g. R₂ of the second measurement loop B₂, is formed by the heater resistor Rc. In this variant embodiment, the first measurement loop B₁ remains identical to the first measurement loops B₁ shown in the variant embodiments of FIGS. 1A and 3A. The measurement loop B₁ is thus arranged on the face 4a of the dielectric substrate 4 and is formed by the contact pad P₁, the electrical connection track 6₁, the first electrode 6, the electrical connection track 16 provided with the diagnostic resistor R₁, and the contact pad P₅.

The second measurement loop B₂ thus includes, in series, the heater resistor Rc, and the second detection electrode 7. When the heater resistor Rc and the second detection electrode 7 are placed on the two distinct faces 4b and 4a respectively of the dielectric substrate 4, the electrical connection tracks are arranged in such a manner as to obtain an electrical connection through the thickness of the dielectric substrate 4. Thus, the second measurement loop B₂ includes the contact pad P₄, the electrical connection track 12, the heater resistor Rc, and the electrical connection track 11 arranged on the second face 4b of the dielectric substrate 4. The electrical connection track 11 is electrically connected to the electrical track 7₁ arranged on the first face 4a via common connection pads P11ₐ and P7₁ respectively. The electrical connection track 7₁ is connected in series with the second electrode 7 that is extended by an electrical connection track 21 also arranged on the first face 4a. The electrical connection track 21 is connected to the contact pad P₃ by means of common connection pads P21 and P11_{b}, the common connection pad P11_{b} being connected to the contact pad P₃.

The invention thus seeks to propose a method of determining the operating state of a measuring probe for measuring the quantity of soot deposited on a collection surface 2. The method thus consists in placing at least one detection electrode 6, 7 in a measurement loop B₁, B₂, and in detecting the variations in electric resistance of the measurement loop so as to determine the operating state of the detection electrode. Advantageously, the method consists in placing each detection electrode 6, 7 in a measurement loop, and in detecting the variations in electric resistance of each measurement loop so as to determine the operating state of the detection electrodes 6, 7.

In an advantageous variant embodiment, at least one resistor R₁, R₂ of known resistance is placed in series with each detection electrode 6, 7. Thus, each measurement loop B₁, B₂ presents a determined resistance.

In order to detect a variation in the resistance in each measurement loop, the method advantageously makes provision to inject an electric current of known value into each of the measurement loops.

It should be observed that the method of the invention makes it possible to know the resistance(s) of the diagnostic resistor(s) R₁, R₂. The resistance of the or each diagnostic resistor R₁, R₂ is determined from the known value of the current flowing through the measurement loop and the known value of the voltage at the terminals of the measurement loop. Determining the resistance of at least one diagnostic resistor makes it possible to deduce the temperature of the measuring probe.

The invention is not limited to the embodiments that are described and shown, since various modifications can be applied thereto without going beyond the ambit of the invention.

1. A method of determining the operating state of a measuring probe (3) for measuring the quantity of soot deposited on a collection surface (2), said probe including detection electrodes (6, 7) that are arranged in adjacent manner and that are for connecting to an electronic system (15) that is capable of evaluating the quantity of soot that has been deposited, said method comprising:
placing at least one detection electrode (6, 7) in a measurement loop (B₁, B₂); and
detecting the variations in the electric resistance of the measurement loop (B₁, B₂), so as to determine the operating state of the detection electrodes (6, 7).

2. A method according to claim 1, wherein a detection electrode (6, 7) is determined as being in an inoperative state when the variation in the electric resistance of the measurement loop including said detection electrode, exceeds a determined value.

3. A method according to claim 1, wherein at least one diagnostic resistor (R₁, R₂) of determined resistance is placed in series with each detection electrode (6, 7).

4. A method according to claim 3, comprising placing the diagnostic resistor (R₁, R₂) on a soot collection surface (2, 2₁) that optionally corresponds to the collection surface (2) including the detection electrodes (6, 7), or away from a soot collection surface.

5. A method according to claim 3, comprising placing the diagnostic resistor (R₁, R₂) in register with the collection surface, so as to form a heater resistor (Rc) for regenerating the collection surface (2).

6. A method according to claim 1, comprising injecting a current of known value into each of the measurement loops (B₁, B₂), so as to detect variation in the electric resistance thereof.

7. A method according to claim 6, comprising injecting the current at regular intervals or after each stage of regenerating the detection electrodes (6, 7);

8. A method according to claim 6, comprising determining the resistance of at least one diagnostic resistor (R₁, R₂), so as to deduce the temperature of the measuring probe.

9. A measuring device for measuring soot deposition, said device comprising a measuring probe (3) for measuring the quantity of soot deposited on a collection surface (2) of an elongate dielectric substrate (4), said probe including detection electrodes (6, 7) that are arranged in adjacent manner and that are for connecting to an electronic system that is capable of evaluating the quantity of soot deposited on the collection surface, wherein for at least one detection electrode (6, 7), a measurement loop (B₁, B₂) that includes said at least one detection electrode (6, 7) and that is connected to a detection system (15) for detecting the variation in the electric resistance of said measurement loop, so as to determine the operating state of said detection electrode.

10. A measuring device according to claim 9, wherein the dielectric substrate (4) is in the form of an elongate plate defining a distal portion (4₁) and a proximal portion (4₂) and having first and second main faces (4a, 4b), the detection electrodes (6, 7) and the collection surface (2) being arranged on one of the main faces at the distal portion of the plate, at least one detection electrode (6, 7) being connected in series with at least one diagnostic resistor (R₁, R₂) of determined resistance, arranged on at least one of the main faces of the plate.

11. A measuring device according to claim 10, wherein a diagnostic resistor (R₁, R₂) is placed on a soot collection surface (2, 2₁) that optionally corresponds to the collection surface including the detection electrodes.

12. A measuring device according to claim 10, wherein a diagnostic resistor (R₁, R₂) is placed away from the collection surface (2, 2₁).

13. A measuring device according to claim 10, wherein a diagnostic resistor (R₁, R₂) is placed in register with the collection surface (2), so as to form a heater resistor (Rc) for regenerating the collection surface.

14. A measuring device according to claim 10 wherein at least one measurement loop (B₁, B₂) comprises an electrical connection track (6₁, 7₁) directly connecting the detection electrode (6, 7) to a contact pad (P₁, P₂) situated at the proximal portion of the plate, and an electrical connection track (16, 21) passing via a diagnostic resistor (R₁, R₂), between the detection electrode and a contact pad (P₅, P₆) situated at the proximal portion of the plate.

15. A measuring device according to claim 14, wherein at least one electrical connection track (21) includes one portion arranged on one main face (4a) and another portion arranged on the other main face (4b) of the dielectric plate (4), the two portions being electrically connected together through the thickness of the dielectric plate (4), in such a manner that one of the contact pads of a measurement loop is situated on one main face while the other contact pad of the measurement loop is situated on the other main face.
